(19) United States
(12) Patent Application Publication
(10) Pub. No.: US 2008/0003485 A1
(43) Pub. Date: Jan. 3, 2008

(54) Fuel cell having patterned solid proton conducting electrolytes

(76) Inventors: Ramkumar Krishnan, Gilbert, AZ (US); William J. Dauksher, Mesa, AZ (US); Chowdary R. Koripella, Scottsdale, AZ (US)

Correspondence Address: INGRASSIA FISHER & LORENZ, P.C., 7150 E. CAMELBACK, STE. 325, SCOTTSDALE, AZ, 85251, US

(21) Appl. No.: 11/479,737

(22) Filed: Jun. 30, 2006

(51) Int. Cl. H01M 4/86; H01M 8/10; B05D 5/12; H01M 4/88

(52) U.S. Cl. 429/44; 427/115; 502/101; 429/30

(57) ABSTRACT

A method is provided for patterning a solid proton conducting electrolyte (22, 60) for a micro fuel cell. The method comprises patterning a first side (30, 63) of a solid proton conducting electrolyte (22, 60) to increase the surface area, coating the patterned first side (22, 60) with an electrocatalyst (33, 66), providing a first electrical conductor (20) to the first side (22, 60), and providing a second electrical conductor (15, 16) to a second side (19) of the solid proton conducting electrolyte (22, 60) opposed to the first side (22, 60). One exemplary embodiment comprises depositing a solid proton conducting electrolyte (60) over a substrate (12), patterning the solid proton conducting electrolyte (60) to form a plurality of pedestals (28), each pedestal (28) having an anode side adjacent a anode region (42) and a cathode side adjacent a cathode region (43), coating the anode (42) and cathode (43) sides with an electrocatalyst (33), providing a first electrical conductor (15, 16) to the anode side (42); and providing a second electrical conductor (20) to the cathode side (43).

### FIELD OF THE INVENTION

The present invention generally relates to fuel cells and more particularly to a method of fabricating a fuel cell by patterning a solid proton conducting electrolyte.

### BACKGROUND OF THE INVENTION

Rechargeable batteries are currently the primary power source for cell phones and various other portable electronic devices. The energy stored in the batteries is limited. It is determined by the energy density (Wh/L) of the storage material, its chemistry, and the volume of the battery. For example, for a typical Li ion cell phone battery with a 250 Wh/L energy density, a 10 cc battery would store 2.5 Wh of energy. Depending upon the usage, the energy could last for a few hours to a few days. Recharging always requires access to an electrical outlet. The limited amount of stored energy and the frequent recharging are major inconveniences associated with batteries. Accordingly, there is a need for a longer lasting, easily recharging solution for cell phone power sources. One approach to fulfill this need is to have a hybrid power source with a rechargeable battery and a method to trickle charge the battery. Important considerations for an energy conversion device to recharge the battery include power density, energy density, size, and the efficiency of energy conversion.

Energy harvesting methods such as solar cells, thermoelectric generators using ambient temperature fluctuations, and piezoelectric generators using natural vibrations are very attractive power sources to trickle charge a battery. However, the energy generated by these methods is small, usually only a few milliwatts. In the regime of interest, namely, a few hundred milliwatts, this dictates that a large volume is required to generate sufficient power, making it unattractive for cell phone type applications.

An alternative approach is to carry a high energy density fuel and convert this fuel energy with high efficiency into electrical energy to recharge the battery. Radioactive isotope fuels with high energy density are being investigated for portable power sources. However, with this approach the power densities are low and there also are safety concerns associated with the radioactive materials. This is an attractive power source for remote sensor-type applications, but not for cell phone power sources. Among the various other energy conversion technologies, the most attractive one is fuel cell technology because of its high efficiency of energy conversion and the demonstrated feasibility to miniaturize with high efficiency.

Fuel cells with active control systems and those capable of operating at high temperatures are complex systems and are very difficult to miniaturize to the 2-5 cc volume needed for cell phone application. Examples of these include active control direct methanol or formic acid fuel cells (DMFC or DFAFC), reformed hydrogen fuel cells (RHFC), and solid oxide fuel cells (SOFC). Passive air-breathing hydrogen fuel cells, passive DMFC or DFAFC, and biofuel cells are attractive systems for this application. However, in addition to the miniaturization issues, other concerns include supply of hydrogen for hydrogen fuel cells, lifetime and energy density for passive DMFC and DFAFC, and lifetime, energy density and power density with biofuel cells.

Conventional DMFC and DFAFC designs comprise planar, stacked layers for each cell. Individual cells may then be stacked for higher power, redundancy, and reliability. The layers typically comprise graphite, carbon or carbon composites, polymeric materials, metal such as titanium and stainless steel, and ceramic. The functional area of the stacked layers is restricted, usually on the perimeter, by vias for bolting the structure together and accommodating the passage of fuel and an oxidant along and between cells. Additionally, the planar, stacked cells derive power only from a fuel/oxidant interchange in a cross-sectional area (x and y coordinates).

To design a fuel cell/battery hybrid power source in the same volume as a typical mobile device battery (10 cc-2.5 Wh), both a smaller battery and a fuel cell with high power density and efficiency would be required to achieve an overall energy density higher than that of the battery alone. For example, for a 4-5 cc (1.0-1.25 Wh) battery to meet the peak demands of the phone, the fuel cell would need to fit in 1-2 cc, with the fuel taking up the rest of the volume. The power output of the fuel cell needs to be 0.5W or higher to be able to recharge the battery in a reasonable time. Most development activities on small fuel cells are attempts to miniaturize traditional fuel cell designs, and the resultant systems are still too big for mobile applications. A few micro fuel cell development activities have been disclosed using traditional silicon processing methods in planar fuel cell configurations, and in a few cases, porous silicon is employed to increase the surface area and power densities. See, for example, U.S. Patent/Publication Nos. 2004/0185323, 2004/0058226, 6,541,149, and 2003/0003347. However, the power densities of the air-breathing planar hydrogen fuel cells are typically in the range of 50-100 mW/cm². To produce 500 mW would require 5 cm² or more active area. Further, the operating voltage of a single fuel cell is in the range of 0.5-0.7V. At least four to five cells need to be connected in series to bring the fuel cell operating voltage to 2-3V and for efficient DC-DC conversion to 4V in order to charge the Li ion battery. Therefore, the traditional planar fuel cell approach will not be able to meet the requirements in a 1-2 cc volume for a fuel cell in the fuel cell/battery hybrid power source for cell phone use.

Accordingly, it is desirable to provide an integrated micro fuel cell apparatus that derives power from a three-dimensional fuel/oxidant interchange having increased surface area. In any typical polymer electrolyte fuel cell, the kinetics of the hydrogen oxidation reaction are faster on the anode side compared to the oxygen reduction reaction on the cathode side. It is desirable to increase both of these reaction rates, but particularly the oxygen reaction rate by increasing the catalytic activity or by providing higher surface area for the reaction. Furthermore, other desirable features and characteristics of the present invention will become apparent from the subsequent detailed description of the invention and the appended claims, taken in conjunction with the accompanying drawings and this background of the invention.

### BRIEF SUMMARY OF THE INVENTION

A method is provided for patterning a solid proton conducting electrolyte for a micro fuel cell. The method comprises patterning a first side of a solid proton conducting electrolyte to increase the surface area, coating the patterned first side with an electrocatalyst or an electrocatalyst/ionomer, providing a first electrical conductor to the first side, and providing a second electrical conductor to a second side of the solid proton conducting electrolyte opposed to the first side.

### BRIEF DESCRIPTION OF THE DRAWINGS

The present invention will hereinafter be described in conjunction with the following drawing figures, wherein like numerals denote like elements, and

FIGS. 1-6 are partial cross-sectional views of two fuel cells as fabricated in accordance with an exemplary embodiment;

FIG. 7 is a partial cross-sectional top view taken along the line 7-7 of FIG. 6;

FIGS. 8-10 are partial cross-sectional views of a fuel cell as fabricated in accordance with a second exemplary embodiment;

FIG. 11 is a partial cross-sectional view of a fuel cell as fabricated in accordance with a third exemplary embodiment; and

FIGS. 12-14 are partial top views of additional exemplary embodiments.

### DETAILED DESCRIPTION OF THE INVENTION

The following detailed description of the invention is merely exemplary in nature and is not intended to limit the invention or the application and uses of the invention. Furthermore, there is no intention to be bound by any theory presented in the preceding background of the invention or the following detailed description of the invention.

The main components of a micro fuel cell device are a proton conducting electrolyte separating the reactant gases of the anode and cathode regions, an electrocatalyst which helps in the oxidation and reduction of the gas species at the anode and cathode of the fuel cell, a gas diffusion region to provide uniform reactant gas access to the anode and cathode, and a current collector for efficient collection and transportation of electrons to a load connected across the fuel cell. Other optional components are an ionomer intermixed with electrocatalyst and/or a conducting support for electrocatalyst particles that help in improving performance. In fabrication of the micro fuel cell structures, the design, structure, and processing of the electrolyte is critical to high energy and power densities, and improved lifetime and reliability. A process is described herein to improve the surface area of the electrolyte, resulting in enhanced electrochemical contact area, a high aspect ratio three-dimensional fuel cell, and a simplified integration and processing scheme. The three-dimensional fuel cell may be fabricated from a free-standing membrane, e.g., a solid proton conducting electrolyte such as Nafion (a registered trademark of DuPont de Nemours), or integrated as a plurality of micro fuel cells. A traditional way of incorporating electrolyte material into the micro fuel cell structure requires selective filling processes such as ink-jet dispensing of the Nafion or a process to remove the Nafion film from the unwanted areas of the fuel cell. The process described in this invention provides a method to fabricate three-dimensional fuel cells from a free-standing Nafion membrane or a process to integrate Nafion electrolyte into the plurality of micro fuel cells. Improved mechanical integrity is achieved compared to selective mechanical removal of the Nafion film from the unwanted areas of the fuel cell structure, and greatly increased throughput is achieved compared to the selective filling processes such as ink-jet dispensing of Nafion. Furthermore, gas diffusion paths may be patterned in the Nafion electrolyte.

Fabrication of individual micro fuel cells as high aspect ratio micro pores provides a high surface area for proton exchange between a fuel (anode) and an oxidant (cathode). At these small dimensions, precise alignment of the anode, cathode, electrolyte and current collectors is required to prevent shorting of the cells. This alignment may be accomplished by semiconductor processing methods used in integrated circuit processing. Functional cells may also be fabricated in ceramic, glass or polymer substrates. This invention provides a method to fabricate a three-dimensional micro fuel cell that has a surface area greater than the substrate and, therefore, higher power density per unit volume.

The fabrication of integrated circuits, microelectronic devices, micro electro mechanical devices, microfluidic devices, and photonic devices, involves the creation of several layers of materials that interact in some fashion. One or more of these layers may be patterned so various regions of the layer have different electrical or other characteristics, which may be interconnected within the layer or to other layers to create electrical components and circuits. These regions may be created by selectively introducing or removing various materials. The patterns that define such regions are often created by lithographic processes. For example, a layer of photoresist material is applied onto a layer overlying a wafer substrate. A photomask (containing clear and opaque areas) is used to selectively expose this photoresist material by a form of radiation, such as ultraviolet light, electrons, or x-rays. Either the photoresist material exposed to the radiation, or that not exposed to the radiation, is removed by the application of a developer. An etch may then be applied to the layer not protected by the remaining resist, and when the resist is removed, the layer overlying the substrate is patterned. Alternatively, an additive process could also be used, e.g., building a structure using the photoresist as a template.

Parallel micro fuel cells in three dimensions fabricated using optical lithography processes typically used in semiconductor integrated circuit processing produces fuel cells with the required power density in a small volume. The cells may be connected in parallel or in series to provide the required output voltage. Functional micro fuel cells are fabricated in micro arrays (formed as pedestals) in the substrate. The anode/cathode ion exchange occurs in three dimensions with the anode and cathode areas separated by an insulator. Multiple metallic conductors are used as the anode and cathode for gas diffusion and also for current collection. An electrocatalyst is deposited on the walls of the electrolyte. Alternatively, an electrocatalyst on a conducting support such as carbon with an ionomer is deposited on the walls of the electrolyte.

In the three-dimensional micro fuel cell design of the exemplary embodiment with thousands of micro fuel cells connected in parallel, the current carried by each cell is small. In case of failure in one cell, in order to maintain a constant current, it will cause only a small incremental increase in current carried by the other cells in the parallel stack without detrimentally affecting their performance.

FIGS. 1-15 illustrate exemplary processes to fabricate fuel cells with a semiconductor-like process on silicon, glass, ceramic, plastic, or a flexible substrate. Referring to FIG. 1, a thin layer 14 of titanium is deposited on a substrate 12 to provide adhesion for subsequent metallization layers and may also be an electrical back plane (for I/O connections, current traces, etc.). The layer 14 may have a thickness in the range of 10-1000 Å, but preferably is 100 Å. Metals other than titanium may be used, e.g., tantalum, molybdenum, tungsten, chromium. A first conductive layer 16, e.g., a metal, is deposited on the layer 14 for good conduction and preferably is gold since it is a noble metal more suitable in the oxidizing/reducing atmospheres seen during the operation of the fuel cell.

Referring to FIG. 2, the gold layer 16 is then patterned and etched for providing contacts to elements described hereinafter (alternatively, a lift-off process could be used), and an oxide layer 18 is deposited thereon. A second conductive layer 20, e.g., gold, is deposited on the layer 18 and patterned and etched for providing contacts to elements described hereinafter. The layers 16 and 20 may have a thickness in the range of 100 Å-1.0 micrometer, but layer 16 is preferably 1000 Å. Metals for the first and second conductive layers other than gold, may include, e.g., platinum, silver, palladium, ruthenium, nickel, copper. A via 15 is then created and filled with metal to bring the electrical contact of gold layer 16 to the surface 19 of dielectric layer 18.

Referring to FIG. 3 and in accordance with the exemplary embodiment, a solid proton conducting electrolyte 22 is formed on the surface 19 and the second metal layer 20. Examples of the solid proton conducting electrolyte 22 include polyelectrolytes such as perfluorosulphonic acid (Nafion®) film, acid doped poly benzimidazole, sulfonated derivates of polystyrene, poly phosphozene, polyether ether ketone, poly(sulfone), poly(imide) and poly(arylene) ether sulphone. Perfluorosulphonic acid has a very good ionic conductivity (0.1 S/cm) at room temperature when humidified. The solid proton conducting electrolyte 22 preferably is spin coated, but other methods such as casting or lamination of a prefabricated Nafion film could also be used. Electrolyte films on various substrates, e.g., glass, plastic, and silicon, can be made by spin coating a solution containing electrolyte and other additives such as solvent and/or water. The substrate may be conducting, semiconducting, insulating, or semi-insulating. The substrate may also have a film or multilayers of conducting, semiconducting, semi-insulating or insulating material thereon. Electrolyte film thickness can be controlled by changing the spin rate and viscosity of the solution containing electrolyte, e.g., 10 wt % Nafion in water at 1000 rpm gives a thickness of 650 nm. Film thickness can also be changed by spin coating multiple times. The films may be dried between room temperature and 100° C. to remove excess water and solvent from the film after spin coating. Thicker electrolyte films can be made either by casting an electrolyte containing-solution or by bonding a free standing electrolyte membrane. Bonding may be performed by hot compression technique at elevated temperature (up to temperatures corresponding to the glass transition temperature of the electrolyte) using applied pressure. Bonding of free-standing electrolyte membranes may also be obtained by using surface functionalization techniques using self-assembled monolayers to improve adhesion. Another approach is to spin coat a thin layer of electrolyte or other material that acts as a glue layer and placing a free-standing electrolyte with or without an applied pressure. Catalysts such as platinum or platinum on carbon may also be loaded in the free-standing electrolyte on one or both surfaces prior to bonding. After forming the electrolyte layer 22 by one of the above mention techniques, a mask layer 24 is deposited on the solid proton conducting electrolyte 22 and a pattern forming layer 26 is formed on the mask layer 24. Mask layer 24 is chosen such that it is resistant to the electrolyte patterning processes such as plasma etch and can be a conducting, semiconducting, or insulating layer. The pattern forming layer 26 can be a photo-patternable layer such as photoresist processed by conventional semicoductor processes such as spin coating and lithography. Alternatively, the pattern forming layer 26 can be a porous layer formed by self assembly processes such as self-assembly of porous anodic alumina, block co-polymer self-assembly, or colloidal templating. Using a self-assembly process to form layer 26 allows for non-lithographic fabrication of patterned electrolytes and therefore low cost and high throughput. The pattern from layer 26 is then transferred to the mask layer 24 by conventional patterning processes such as wet or dry chemical etching, sputtering or ion-milling. The mask layer 24 is optional when the pattern forming layer 26 is used as a mask to directly pattern the electrolyte 22.

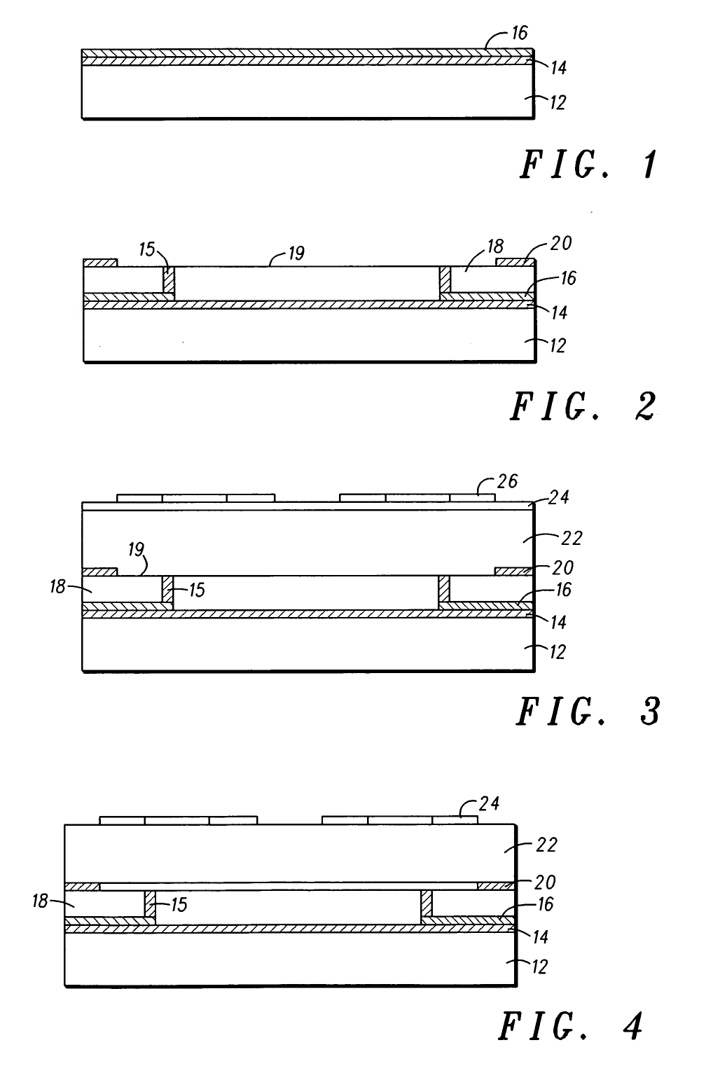

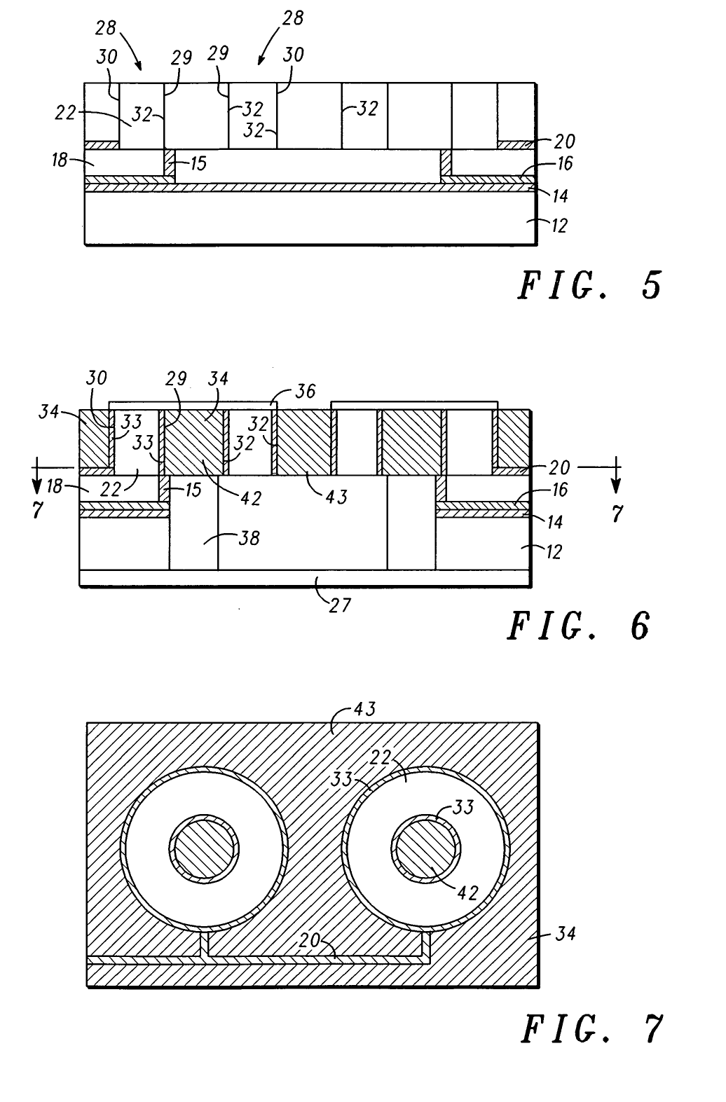

Referring to FIGS. 4-5, using a chemical etch, the mask layer 24 not protected by the pattern forming layer 26 is removed. Then, after the pattern forming layer 26 is removed, the solid proton conducting electrolyte 22 not protected by the mask layer 24, is removed to form a pedestal 28 comprising an anode inner side 29 and a concentric cathode outer side 30. The concentric outer side 30 and the anode inner side 29 are separated by the solid proton conducting electrolyte 22. In a preferred embodiment, the removal of the solid proton conducting electrolyte is accomplished with a dry plasma etch. The plasma gas may be argon or other chemistries, but preferably is oxygen. This oxygen-based, high-density etch will work over a large process window. Representative conditions are as follows: 900W u-wave, 50W RIE, 30 sccm O₂, 4 mT, with He-cooled chuck. Etch rates may reach 5 um/minute. Alternatively, the electrolyte may be patterned by milling, laser-machining or sputtering techniques. The pedestal 28 preferably has a diameter of 10 to 100 microns. The distance between each pedestal 28 would be 10 to 100 microns, for example. Concentric as used herein means having a structure having a common center, but the anode and cathode walls may take any form and are not to be limited to circles. For example, the pedestals 28 may alternatively be formed by etching orthogonal trenches.

The side walls 32 are then coated with an electrocatalyst 33 for anode and cathodic fuel cell reactions by wash coat or some other deposition method such as CVD, ALD, PVD, electrochemical or chemical deposition approach (FIG. 6). A multi-metal layer 34 comprising an alloy of two metals, e.g., silver/gold, copper/silver, nickel/copper, copper/cobalt, nickel/zinc or nickel/iron, and having a thickness in the range of 100-500 um, but preferably 200 um, is deposited on the layer 18 and metal 20. The multi-metal layer 34 is then wet etched to remove one of the metals, leaving behind a porous material. The porous metal layer could also be formed by other methods such as templated self-assembled growth or sol-gel deposition.

Alternatively, the porous layer may be first grown by the above mentioned techniques followed by coating the walls of the porous layer and/or the the porous layer-electrolyte interface with an electrocatalyst. The electrocatalyst may be coated by CVD, ALD, PVD, electrochemical or chemical deposition of electrocatalyst from solution.

Then a capping layer 36 is formed and patterned above the electrolyte material 22, fuel region 42, and the multi-metal layer 34. The capping layer 36 is substantially imperameable to hydrogen and may comprise, e.g., a conducting layer, a semiconducting layer, or an insulating layer, but preferably comprises a dielectric layer. FIG. 6 shows the case of an insulating capping layer. If a conducting or semiconducting layer were used, the capping layer width is such that there would be no short between the anode and cathode. A via, or cavity, 38 is formed in the substrate 12 by a conventional etching (wet or dry) method. The silicon substrate 12, or the substrate containing the micro fuel cells, is positioned on a structure 27 for transporting hydrogen to the vias 38. The structure 27 may comprise a cavity or series of cavities (e.g., tubes or passageways) formed in a ceramic material, for example. Hydrogen would then enter the hydrogen sections 42 of multi-metal layer 18 above the vias 38. Since sections 42 are capped with the capping layer 36, the hydrogen would stay within the sections 42. Oxidant sections 43 are open to the ambient air, allowing air (including oxygen) to enter oxidant sections 43. Oxidant section 43 may optionally be patterned, such as with a via, to improve passage of air.

FIG. 7 illustrates a top view of adjacent fuel cells fabricated in the manner described as concentric circles in reference to FIGS. 1-6. The electrolyte material solid proton conducting electrolyte 22 will form a physical barrier between the anode 42 (hydrogen feed) and cathode 43 (air breathing) regions. Gas manifolds 27 are built into the bottom packaging substrate to feed hydrogen gas to all the anode regions. Since it is capped on the top 36, it will be like a dead-end anode feed configuration fuel cell.

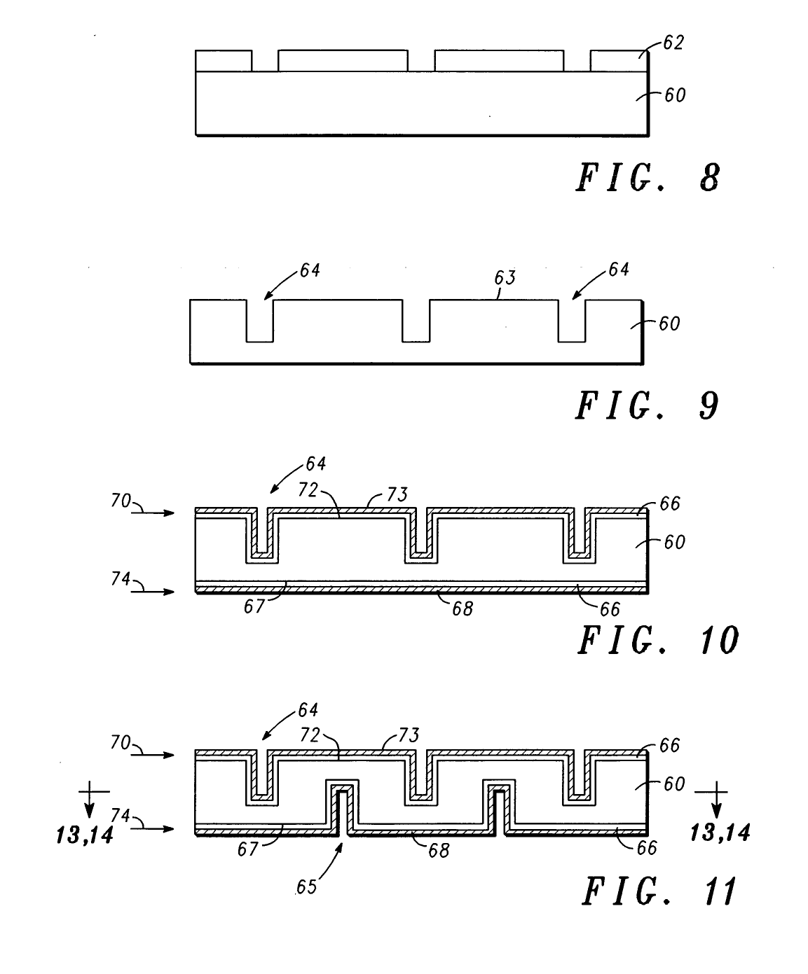

A second exemplary embodiment is shown in FIG. 10. Considering FIG. 8, a mask 62, e.g., a photoresist, oxide, or nitride, is patterned by, e.g., lithography, screen printing, or laminated on a solid proton conducting electrolyte 60. The solid proton conducting electrolyte 60 may be free-standing or formed, e.g., spin coated or laminated, on a substrate (not shown). The substrate may comprise, for example, silicon, glass, ceramic, plastic, or a flexible substrate.

Referring to FIG. 9, a dry etch is performed using an oxygen plasma under an applied bias to remove all or a portion of the solid proton conducting electrolyte 60 not protected by the mask 62. The mask 62 is then removed and the patterned surface 63 coated with an electrocatalyst 66 (FIG. 10), for anode or cathodic fuel cell reactions, by wash coat or some other deposition methods such as CVD, PVD, chemical or electrochemical deposition. Other components such as ionomer and a conducting support for electrocatalyst may be added in the electrocatalyst layer. The etching of the solid proton conducting electrolyte 60 creates grooves 64, thereby increasing the surface area of the solid proton conducting electrolyte 60 upon which the electrocatalyst 66 is deposited. Electrocatalyst 66 is also applied to the other side 67 of the electrolyte 60. Porous conducting material layers 68 and 73 are formed on the electrocatalyst 66 on opposed sides 67 and 72, respectively, for making electrical contact thereto. An oxidant 70 or fuel 74 is passed over the patterned and the non-patterned surfaces of the porous conducting material layers along the surface to establish a proton migration through the solid proton conducting electrolyte 60. Preferably the oxidant 70 is flowed along the patterned surface of the electrolyte, which will increase the overall fuel cell performance due to the increased reaction rate because of the increased surface area on that side.

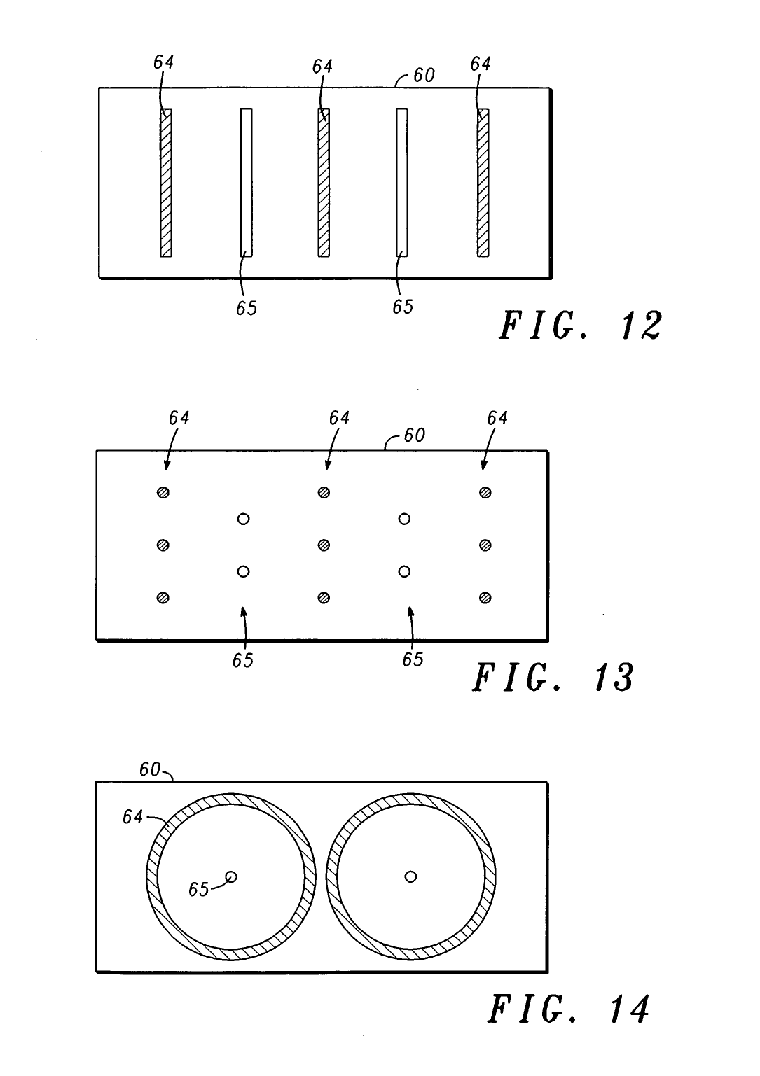

In a third exemplary embodiment (FIG. 11), the solid proton conducting electrolyte 60 is etched, in a similar manner as the exemplary embodiment of FIG. 10, on two surfaces 67 and 72 to provide grooves 64 and 65. The electrocatalyst 66 is deposited on both surfaces 67 and 72. Porous conducting material layers 68 and 73 are formed on the electrocatalyst 66 on opposed sides 67 and 72, respectively, for making electrical contact thereto. The fuel 74 may be directed along the conductor 68 and the oxidant 70 may be directed along the conductor 73.

The electrocatalyst 66, for the embodiments of FIGS. 10 and 11 for example, may optionally fill the grooves 64 and 65, partially or up to even with the surface 73 and 68, respectively, without impacting the surface area of surfaces 67 and 72.

Referring to FIG. 12, a cut away view taken along line 13-13 of FIG. 11, illustrates the exemplary embodiment where grooves 64 and 65 comprising trenches. And FIG. 13, a cut away view taken along line 13 -13 of FIG. 11, illustrates the exemplary embodiment where grooves 64 and 65 comprising cylindrical holes, or vias. FIG. 14 is yet another exemplary embodiment wherein grooves 65 are cylindrical vias and grooves 64 are trenchs concentrically positioned around grooves 65 (cross-section not shown).

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention, it being understood that various changes may be made in the function and arrangement of elements described in an exemplary embodiment without departing from the scope of the invention as set forth in the appended claims.

1. A method of forming a fuel cell comprising:
patterning a first side of a solid proton conducting electrolyte; and
coating the patterned first side with a first electrocatalyst.

2. The method of claim 1 further comprising forming a first porous metal layer on the patterned first side prior to coating with the first electocatalyst.

3. The method of claim 1 further comprising:
providing a first electrical connection to the first electrocatalyst; and
providing a second electrical connection to a second side of the solid proton conducting electrolyte opposed to the first side.

4. The method of claim 3 further comprising, prior to providing a second electrical connection:
patterning the second side of the solid proton conducting electrolyte; and
coating the patterned second side with a second electrocatalyst, wherein the second electrical connection is made to the second electrocatalyst.

5. The method of claim 4 further comprising forming a second porous metal layer on the patterned second side prior to coating with the second electrocatalyst.

6. The method of claim 1 wherein the first side comprises a cathode and the second side comprises an anode.

7. The method of claim 1 wherein the solid proton conducting electrolyte comprises perfluorosulphonic acid.

8. The method of claim 1 wherein the patterning step comprises etching with one of a chemical etch or a dry plasma etch.

9. The method of claim 1 wherein the coating step comprises forming a first layer of an electrocatalyst formed on the patterned first side and forming a second layer of a porous gas conducting material on the first layer.

10. The method of claim 4 wherein the coating the patterned second side comprises forming a first layer of an electrocatalyst formed on the patterned second side and forming a second layer of a porous gas conducting material on the first layer.

11. The method of claim 1 wherein the patterning step comprises using a mask made by one of lithography techniques and self-assembly techniques.

12. A method for fabricating a fuel cell, comprising:
forming a solid proton conducting electrolyte over a substrate;
patterning the solid proton conducting electrolyte to form a plurality of pedestals, each pedestal having a anode side and a cathode side separated by the solid proton conducting electrolyte;
coating the anode and cathode sides with first and second electrocatalysts, respectively;
providing a first electrical conductor to the first electrocatalyst; and
providing a second electrical conductor to the second electrocatalyst.

13. The method of claim 12 further comprising:
defining a fuel region adjacent to the anode side by capping the pedestal with an insulator; and
etching the substrate to provide a via for providing access to the fuel region.

14. The method of claim 12 wherein the electrolyte comprises perfluorosulphonic acid.

15. A fuel cell comprising:
a solid proton conducting electrolyte having a first side containing a first plurality of etched grooves, and a second side opposed to the first side;
a first electrocatalyst formed on the first side and within the etched grooves;
a first electrical conductor making contact with the first electrocatalyst; and
a second electrical conductor coupled to the second side.

16. The fuel cell of claim 15 wherein the second side of the solid proton conducting electrolyte contains a second plurality of etched grooves to increase the surface area, and further comprising a second electrocatalyst formed on the second side and within the second plurality of etched grooves, wherein the second electrical conductor making contact with the second electrocatalyst.

17. The fuel cell of claim 15 wherein the first side comprises a cathode and the second side comprises an anode.

18. The fuel cell of claim 15 wherein the electrocatalyst comprises perfluorosulphonic acid.

19. The fuel cell of claim 15 further comprising:
a fuel region adjacent to the anode side;
an insulator capping the fuel region; and
wherein the substrate defines a via for providing access to the fuel region.

20. The fuel cell of claim 15 wherein the solid proton conducting electrolyte forms a plurality of pedestals as concentric circles.

21. The fuel cell of claim 15 wherein the solid proton conducting electrolyte forms a plurality of pedestals defined by patterned trenches.
